(19) United States
(12) Patent Application Publication
(10) Pub. No.: US 2025/0055410 A1
(43) Pub. Date: Feb. 13, 2025

(54) SIMPLE BEARING FOR SOLAR TRACKING

(71) Applicant: SUN AND STEEL SOLAR LLC, Stateline, NV (US)

(72) Inventor: Robert B. Dally, Stateline, NV (US)

(21) Appl. No.: 18/798,528

(22) Filed: Aug. 8, 2024

Related U.S. Application Data
(60) Provisional application No. 63/531,743, filed on Aug. 9, 2023.

(51) Int. Cl. H02S 20/32; F16C 17/02

(52) U.S. Cl. CPC H02S 20/32; F16C 17/02

(57) ABSTRACT

A single-axis tracker system includes a bearing race including a pair of flanges that each include a slot that limits north-south movement of at least one torque tube that is disposed within the bearing race. A journal-coupler removably connects to the bearing race. A moveable ganged bearing lock holds the at least one torque tube in place while in a stow position.

### CROSS-REFERENCE TO RELATED APPLICATIONS

This application claims the priority benefit of U.S. Provisional Patent Application Ser. No. 63/531,743, filed Aug. 9, 2023, which is incorporated herein by reference in its entirety.

### TECHNICAL FIELD

One or more embodiments relate generally to the locking of the rotation of solar panels, and in particular, a bearing race including a pair of flanges that each include a slot that limits north-south movement of at least one torque tube that is disposed within the bearing race.

### BACKGROUND

Single axis trackers are mounting structures used for the controlled movement of photovoltaic (PV) solar panels and other solar collecting means from east to west to track the sun daily. Bearings are used to properly rotate the PV solar panels to track the sun. These bearings can have ball bearings or roller bearings, or dry bushings, or be a simple bearing of a rotating journal turning and rubbing inside a bearing race. In all these cases, the bearings have minimal friction and holding power. The dynamic oscillation of the solar wing in the wind is stopped by a very strong, stiff and heavy torque tube or by increasing the number of mechanical drives on the row. Some single axis trackers have a drive on every post to have holding power at every post along the row. Typically, there will be ten posts per row. These multiple drives are powered by one motorized drive and a daisy chain of spinning drive shafts interconnected from drive to drive. A drive is essentially a mechanical transmission with a lever arm to turn the solar panels and two splined shafts to accept two driveshafts.

### SUMMARY

One embodiment provides a single-axis tracker system that includes a bearing race including a pair of flanges that each include a slot that limits north-south movement of at least one torque tube that is disposed within the bearing race. A journal-coupler is removably connected to the bearing race. A moveable ganged bearing lock holds the at least one torque tube in place while in a stow position. Some embodiments include the feature that each slot captures a locking block of the moveable ganged bearing lock upon the locking block moved upward into place within each slot. One or more embodiments include the feature that the locking block is released and pulled out of a locking position via gravity. Some embodiments provide the feature that the locking block includes a pair of L-shaped locking portions. Some embodiments include the feature that each of the pair of L-shaped locking positions engage one of the slots in the locking position. One or more embodiments provide the feature that the journal coupler includes a top portion and a bottom portion, and the top portion removably couples to the bottom portion. Some embodiments include the feature that the bottom portion includes a post coupling portion that connects to a support post. One or more embodiments provide the feature that the bearing race, the journal-couple, the moveable ganged bearing lock and the support post are each made of metal. Some embodiments additionally provide the feature that a wire pull rope that is connected with an actuator raises and lowers the locking block in cooperation with multiple ganged cables. Some embodiments further provide the feature that the locking block is connected to the post coupling portion.

Another embodiment provides a system that includes at least one torque tube configured for connecting to one or more photovoltaic (PV) solar panels. A bearing race that includes a pair of flanges that each include a slot that limits north-south movement of the at least one torque tube that is disposed within the bearing race. A journal-coupler is removably connected to the bearing race. A moveable ganged bearing lock holds the at least one torque tube in place while in a stow position. Some embodiments include the feature that each slot captures a locking block of the moveable ganged bearing lock upon the locking block moved upward into place within each slot. One or more embodiments include the feature that the locking block is released and pulled out of a locking position via gravity. Some embodiments provide the feature that the locking block includes a pair of L-shaped locking portions. Some embodiments include the feature that each of the pair of L-shaped locking positions engage one of the slots in the locking position. One or more embodiments provide the feature that the journal coupler includes a top portion and a bottom portion, and the top portion removably couples to the bottom portion. Some embodiments include the feature that the bottom portion includes a post coupling portion that connects to a support post. One or more embodiments provide the feature that the bearing race, the journal-coupler, the moveable ganged bearing lock and the support post are each made of metal. Some embodiments additionally provide the feature that a wire pull rope that is connected with an actuator raises and lowers the locking block in cooperation with multiple ganged cables. Some embodiments further provide the feature that the locking block is connected to the post coupling portion.

### BRIEF DESCRIPTION OF THE DRAWINGS

FIG. 1 shows a three-dimensional (3D) view of a row of solar panels (or photovoltaic (PV) modules) attached to the single axis tracker structure with a 3D view of a single axis tracker underneath the mounted solar panels, according to some embodiments;

FIG. 2 is a close up of FIG. 1 with the solar panels and their attachment rails removed, according to some embodiments;

FIG. 3 shows the I-Beam support post with the locking block resting on the post, according to some embodiments;

FIG. 4 shows the torque tube along with the journal with its two slots (or thrust stops), according to some embodiments;

FIG. 5 shows the locking block, according to some embodiments;

FIG. 6 shows the locking block pulled up into a lock position with the slots of the journal, according to some embodiments;

FIG. 7 shows the routing of a pull cable to both wings with cornering pipes, according to some embodiments;

FIG. 8 shows the journal with two shaped slots (or thrust stop) flanges, according to some embodiments;

FIG. 9 shows upper and lower portions of a bearing race, according to some embodiments;

FIG. 10 shows attachment of the bearing race to an I-beam post, according to some embodiments;

FIG. 11 shows the slots in a ready position for stowing and locking movement of the torque tube, according to some embodiments;

FIG. 12 shows the slots in a ready position for stowing and locking movement of the torque tube with a lock block attached to the post, according to some embodiments;

FIG. 13 shows the assembly of slots in a ready position for stowing with the lock block, according to some embodiments;

FIG. 14 shows the lock block and slots in an inactive stow-stop state, according to some embodiments;

FIG. 15 shows the lock block being lifted towards a locking position into the slots, according to some embodiments;

FIG. 16 shows the lock block lifted into a locked position within the slots, according to some embodiments;

FIG. 17 shows the lock block being at rest allowing for rotation of the journal and the torque tube, according to some embodiments;

FIG. 18 shows the lock block lifted waiting for the torque tube to rotate to a 0 degree position for locking into the slots of the thrust-stop flanges, according to some embodiments;

FIG. 19 shows the lock block lifted with the torque tube rotating to a 0 degree position for locking into the slots of the thrust-stop flanges, according to some embodiments;

FIG. 20 shows the lock block locking the torque tube that was rotated to a ±3 degree position to lock into the slots of the thrust-stop flanges, according to some embodiments;

FIG. 21 shows another view of the lock block locking the torque tube that was rotated to a ±3 degree position to lock into the slots of the thrust-stop flanges, according to some embodiments;

FIG. 22 shows a ganged bearing lock that uses a pull cable to position the lock block, according to some embodiments;

FIG. 23 shows a ganged bearing lock that uses a pull cable to position the lock block that is shown as angle irons, according to some embodiments;

FIG. 24 shows a ganged bearing lock that uses a pull cable to position the lock block that is shown with multiple cables attached, according to some embodiments;

FIG. 25 shows a ganged bearing lock that uses a pull cable to position the lock block that is shown with one of the fasteners positioned lower than the others for missing the slots, according to some embodiments;

FIG. 26 shows a ganged bearing lock that uses a pull cable to position the lock block that is shown with an optional tension spring attached to a pull cable, according to some embodiments;

FIG. 27 shows various elements of the pull cable, according to some embodiments;

FIG. 28A shows a schematic for a six (6) inch slew drive, according to some embodiments;

FIG. 28B shows a schematic for an eight (8) inch slew drive, according to some embodiments;

FIG. 29A shows a side view of a schematic for a six (6) inch slew drive, according to some embodiments;

FIG. 29B shows a side view of a schematic for an eight (8) inch slew drive, according to some embodiments;

FIG. 30A shows additional views of a schematic for a slew drive, according to some embodiments;

FIG. 30B shows further additional views of a schematic for a slew drive, according to some embodiments;

FIG. 31A shows an additional side view of a schematic for a six (6) inch slew drive, according to some embodiments;

FIG. 31B shows an additional side view of a schematic for an eight (8) inch slew drive, according to some embodiments;

FIG. 32A shows additional views of schematics for a six (6) inch slew drive, according to some embodiments; and

FIG. 32B shows additional views of schematics for an eight (8) inch slew drive, according to some embodiments.

### DETAILED DESCRIPTION

The following description is made for the purpose of illustrating the general principles of one or more embodiments and is not meant to limit the inventive concepts claimed herein. Further, particular features described herein can be used in combination with other described features in each of the various possible combinations and permutations. Unless otherwise specifically defined herein, all terms are to be given their broadest possible interpretation including meanings implied from the specification as well as meanings understood by those skilled in the art and/or as defined in dictionaries, treatises, etc.

One or more embodiments relate generally to a bearing lock system for holding and preventing the journaling or rotating of solar panels on a single axis tracking system. Some embodiments utilize at least one actuator to pull into place a series of locking blocks. Each locking block is pulled vertically upward, against gravity, via a series of small pull cables, such that they each lock the journal portion of the bearing to the race portion of the bearing. This movement of the locking blocks transfers all wind torque to each and every post. The journal, torque tube and attached solar panels must be in the wind-stow position for the lock to engage at each bearing.

One embodiment provides a single-axis tracker system that includes a bearing race including a pair of flanges that each include a slot that limits north-south movement of at least one torque tube that is disposed within the bearing race. A journal-coupler is removably connected to the bearing race. A moveable ganged bearing lock holds the at least one torque tube in place while in a stow position. Some embodiments include the feature that each slot captures a locking block of the moveable ganged bearing lock upon the locking block moved upward into place within each slot. One or more embodiments include the feature that the locking block is released and pulled out of a locking position via gravity. Some embodiments provide the feature that the locking block includes a pair of L-shaped locking portions. Some embodiments include the feature that each of the pair of L-shaped locking positions engage one of the slots in the locking position. One or more embodiments provide the feature that the journal coupler includes a top portion and a bottom portion, and the top portion removably couples to the bottom portion. Some embodiments include the feature that the bottom portion includes a post coupling portion that connects to a support post. One or more embodiments provide the feature that the bearing race, the journal-couple, the moveable ganged bearing lock and the support post are each made of metal. Some embodiments additionally provide the feature that a wire pull rope that is connected with an actuator raises and lowers the locking block in cooperation with multiple ganged cables. Some embodiments further provide the feature that the locking block is connected to the post coupling portion.

Another embodiment provides a system that includes at least one torque tube configured for connecting to one or more photovoltaic (PV) solar panels. A bearing race that includes a pair of flanges that each include a slot that limits north-south movement of the at least one torque tube that is disposed within the bearing race. A journal-coupler is removably connected to the bearing race. A moveable ganged bearing lock holds the at least one torque tube in place while in a stow position. Some embodiments include the feature that each slot captures a locking block of the moveable ganged bearing lock upon the locking block moved upward into place within each slot. One or more embodiments include the feature that the locking block is released and pulled out of a locking position via gravity. Some embodiments provide the feature that the locking block includes a pair of L-shaped locking portions. Some embodiments include the feature that each of the pair of L-shaped locking positions engage one of the slots in the locking position. One or more embodiments provide the feature that the journal coupler includes a top portion and a bottom portion, and the top portion removably couples to the bottom portion. Some embodiments include the feature that the bottom portion includes a post coupling portion that connects to a support post. One or more embodiments provide the feature that the bearing race, the journal-coupler, the moveable ganged bearing lock and the support post are each made of metal. Some embodiments additionally provide the feature that a wire pull rope that is connected with an actuator raises and lowers the locking block in cooperation with multiple ganged cables. Some embodiments further provide the feature that the locking block is connected to the post coupling portion.

For some embodiments, the wind stow position exists with no tilt, where the solar panels are positioned horizontally, or at a slight tilt to ensure water runoff. The tilt for a locking position may be at any tilt angle, but generally it will be near zero degrees. The actuator is locked into position once it has pulled the locking blocks into place. In one or more embodiments, the force to pull a gang of locking blocks vertically upward is relatively small, either to pull up or to hold in place once the actuator is static. Most of the forces will be between the journal pinching point, the locking block, and the bearing race pinching points. To release the locking blocks, the actuator does not push the blocks out of the way, but releases them, relying on gravity to pull them downward such that they disengage from the pinching points and allow the journals to turn freely.

One or more embodiments are directed to a simple bearing lock system of a round journal-coupler turning in a round race, the journal having thrust-stops that prevent movement along the axis of rotation (generally north-south), the two slots (or thrust stops) are utilized for the insertion of a blocking piece of steel or other strong material. In some embodiments, the locking block is a physical stop that dumps, or transfers, all wind induced torque to the posts.

It should be noted that most conventional single-axis trackers place drives mechanisms on the plurality of posts for wind hold. That allows wind hold at all angles, but in general all trackers must get to a horizontal stow position to minimize the forces on the solar panels and the torque on the torque tube and drive system. Dynamic amplification factors may cause the structure to gallop if the torque tube is not stiff enough. To prevent wind gallop and wind failure the solution most use is to place multiple drives along the row, often powered by a daisy chain of spinning driveshafts.

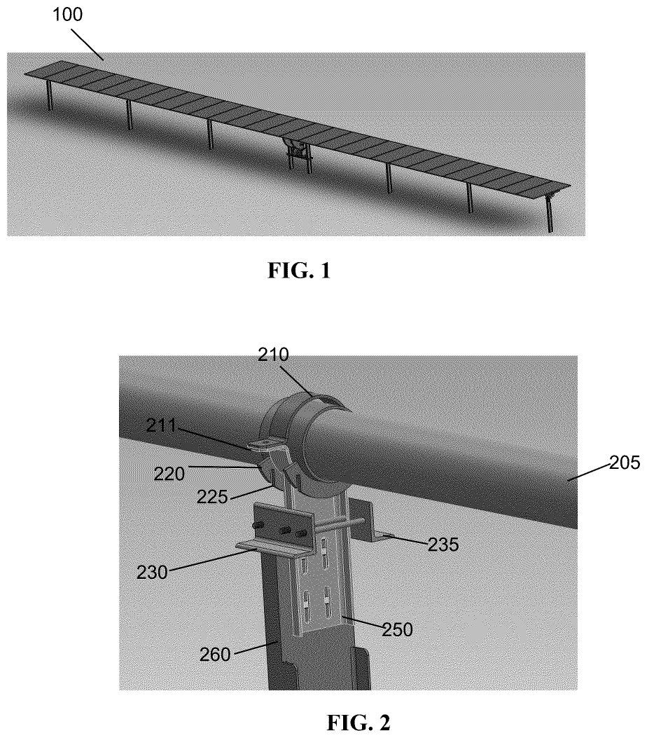

FIG. 1 shows a three-dimensional (3D) view 100 of a row of solar panels (or photovoltaic (PV) modules) attached to the single axis tracker structure with a 3D view of a single axis tracker underneath the mounted PV modules, according to some embodiments. Wind places pressure on the solar modules. To minimize the pressure and the torque transferred to the drive, the solar panels are placed into a horizontal or near horizontal position. As shown in view 100, eight posts hold up the bearings and torque tubes.

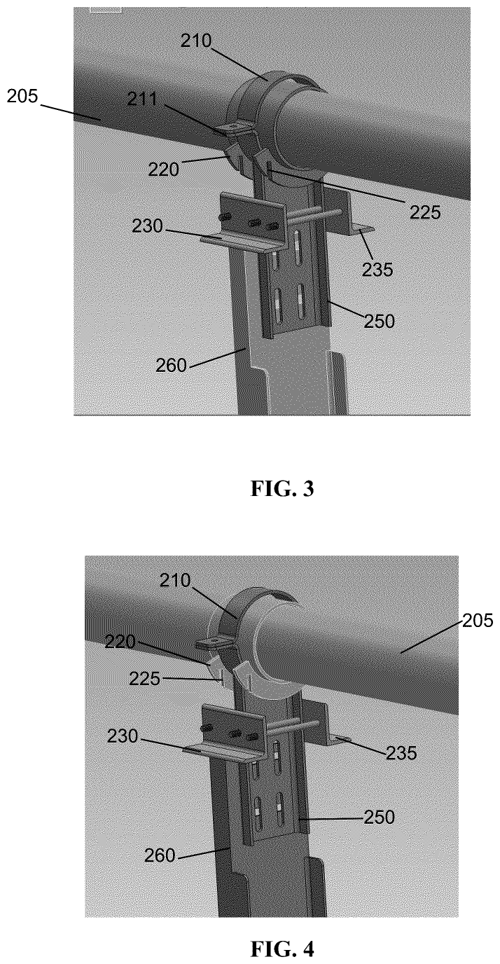

FIG. 2 shows a 3D view of the locking device in a resting position, ready to be lifted up into locking place, according to some embodiments. As shown, the solar panels and their attachment rails removed to expose the bearing (upper bearing race 210, lower bearing race 211 and journal 220) and locking block 230/235. The locking block 230/235 rests on a ledge on the post 260 until a set (e.g., four, etc.) small take-off cables lift the locking block 230/235 into place. The main pull cable may be draped underneath the torque tube 205 and have a small set of take-off cables (e.g., four, etc.) wrapping over the torque tube 205 (e.g., cylindrical shaped, etc.) and down to the locking block 230/235 to lift the locking device straight up and evenly without getting jammed. In some embodiments, one post portion 250 is shown with one bearing race 211 and is attached to the supporting post 260. The journal 220 has two slots 225 (thrust stops, slits, grooves, channels, etc.) for capturing the locking block 230/235 when the locking block 230/235 is pulled vertically upward. The locking block 230/235 rests on a portion of the support post 260 and is pulled up into locking place by a pull-cable system (not shown) placed into tension by an actuator.

FIG. 3 shows the I-Beam support post 260 with the locking block 230/235 resting on the upper portion of the support post 260, according to some embodiments. As shown, the locking block 230/235 is show in an unlocked state.

FIG. 4 shows the torque tube 205 along with the journal 220 with its two slots (or thrust stops) 225, according to some embodiments. Each journal 220 includes a pair of slots 225 that are configured to accept the locking block 230/235 when it is pulled up into place, locking rotation of the journal 220, and thus the torque tube 205.

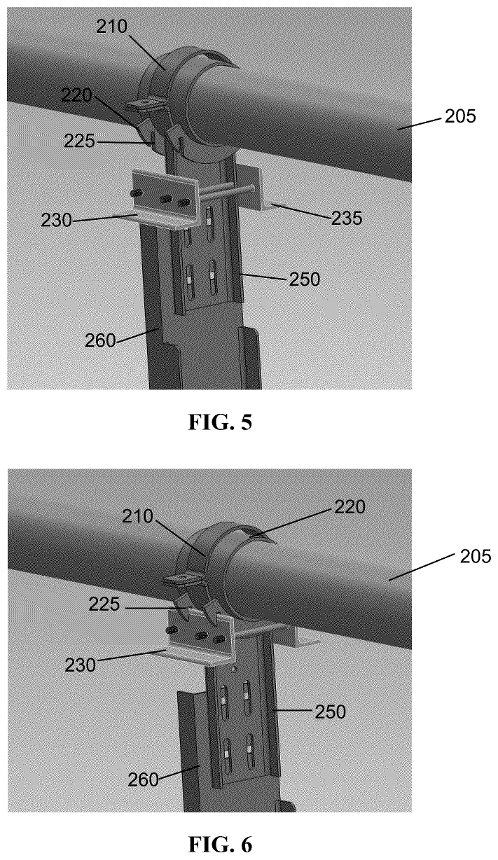

FIG. 5 shows the locking block, according to some embodiments. In one or more embodiments, the locking block may be raised and lowered once the fasteners (e.g., nuts/bolts, screws, etc.) are loosened to allow movement. Once the locking block is loosened and raised, the upper edge slides into the locking block slots of the journal, thus locking movement of the journal and the torque tube(s).

FIG. 6 shows the locking block 230/235 pulled up into a lock position with the slots 225 of the journal 220, according to some embodiments. The locking block 230/235 upper edges (on opposite sides of the journal 220) are locked into the slots 225 of the locking block 230/235 and the fasteners are tightened, which prohibits rotation of the journal 220 and thus, the torque tube(s) 205.

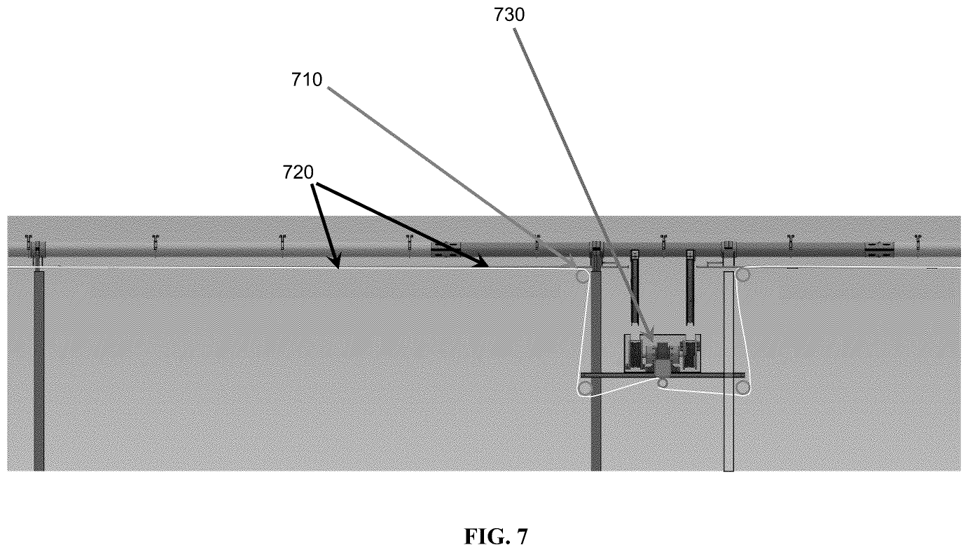

FIG. 7 shows the routing of a pull cable 720 to both wings with cornering pipes 710, according to some embodiments. One or more embodiments include a simple bearing lock for single-axis tracking including a journal 220 (FIG. 2) and a blocking piece of metal (e.g., locking block 230/235, FIG. 2) that is lifted into locking place to hold the torque tube 205 (FIG. 2) at every support post 260 (FIG. 2). The locking block 230/235 is pulled down and out of the way by gravity and is pulled up into locking position with an actuator 730 and tension cable. A thrust-stop (e.g., slots 225, FIG. 2) on the journal 220 straddles the bearing race (210/211, FIG. 2) and has slots 225 for capturing a locking block 230/235 when pulled upward into place. An actuator 730 pulls a ganged bearing lock system for secure wind holding for fixing movement of the torque tube 205, and thus the PV solar panel(s) mounted to the torque tube 205.

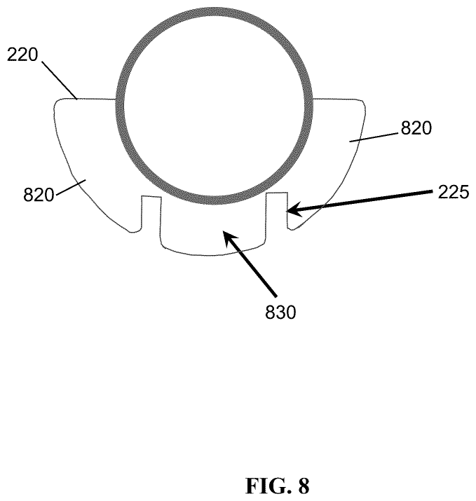

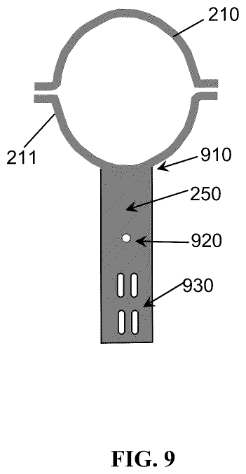

FIG. 8 shows the journal 220 with two shaped thrust stop flanges, according to some embodiments. As shown, the thrust flanges 820 include the slots 225. A center flange 830 is shown between the thrust flanges 820.

FIG. 9 shows upper portion 210 and lower portion 211 of a bearing race, according to some embodiments. The lower portion 211 includes a factory weld 910 to a post portion (or CEE beam) 250. A thru-hole 920 is utilized by using a stow-lock cable. The vertical slots (or openings) 930 provide for attachment to the support post 260 (FIG. 2) using fasteners (e.g., bolts, etc.).

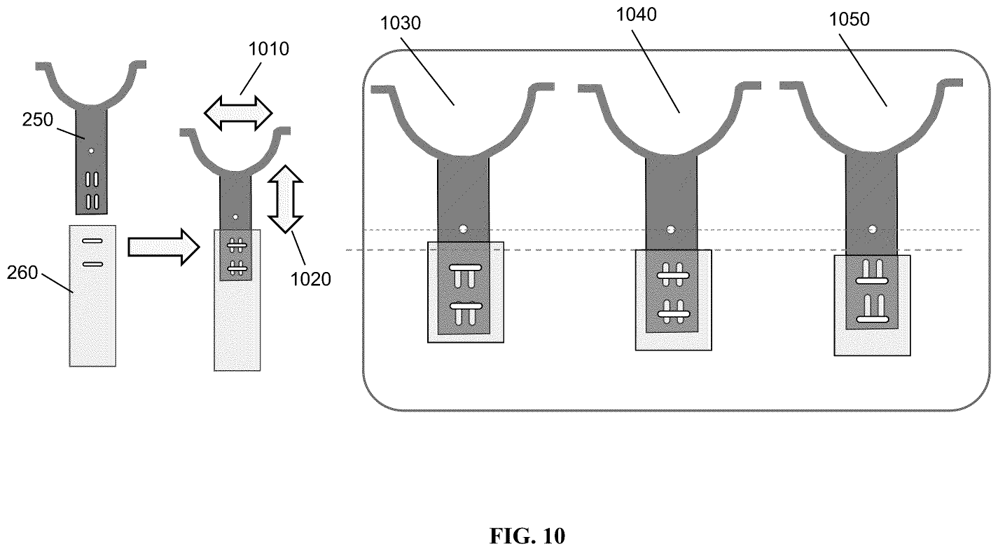

FIG. 10 shows attachment of the bearing race to a support post 260 (or I-beam post), according to some embodiments. The attachment uses horizontal 1010 movement and vertical 1020 movement to align the slots. In view 1030 the post portion 250 is shown at the lowest placement. In view 1040 the post portion 250 is shown at the centered or perfect placement. In view 1050 the post portion 250 is shown at the highest placement.

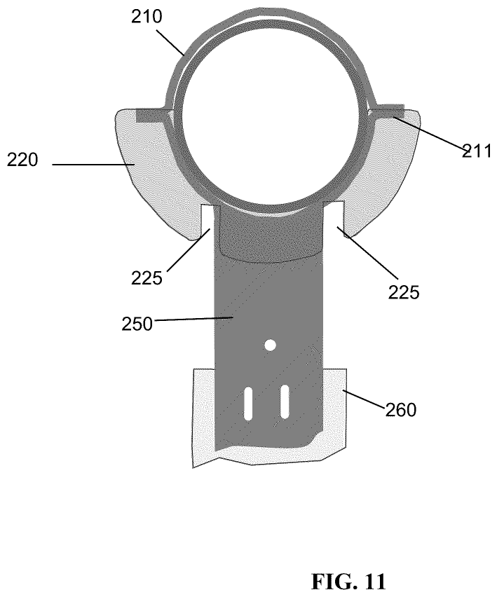

FIG. 11 shows the slots 225 in a ready position for stowing and locking movement of a torque tube, according to some embodiments. In some embodiments, the top portion 210 of the bearing race may be narrower than the lower portion 211 of the bearing race. The slots of the post portion 250 are centered on tabs such that the top portion 210 of the bearing race do not protrude out and catch the passing thrust stop flanges top edges. In one or more embodiments, the thrust stops rub against the lower portion 211 of the bearing race, and never hit against a protruding top of the supporting post 260.

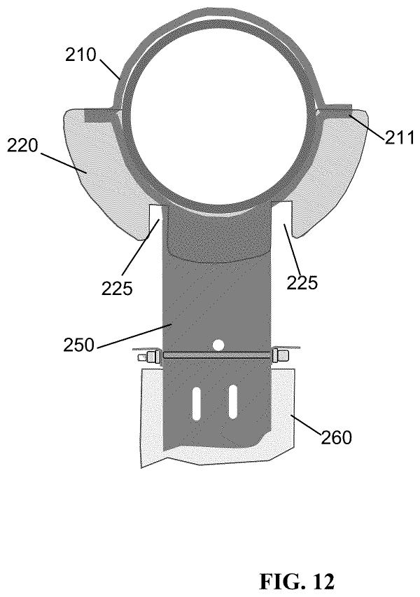

FIG. 12 shows the slots 225 in a ready position for stowing and locking movement of a torque tube with a lock block 230/235 attached to the post position 250, according to some embodiments.

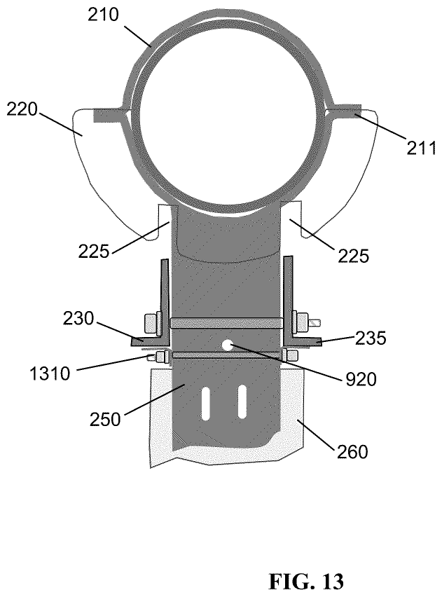

FIG. 13 shows the assembly of slots 225 in a ready position for stowing with the lock block 230/235, according to some embodiments. In one or more embodiments, the lock block 230/235 is resting on an adjustable platform 1310 (e.g., small angle “L” pair that may be bolted on the post portion 250). In this position, the lock block 230/235 cannot interfere with a pull cable that may be inserted through the thru-hole 920. In one or more embodiments, the angle “L” pair of the lock block 230/235 is held in place by a sleeve over the fasteners (e.g., bolts) loose enough to slide upward and downward by wire cables and lowered via gravity during release of the pull cable.

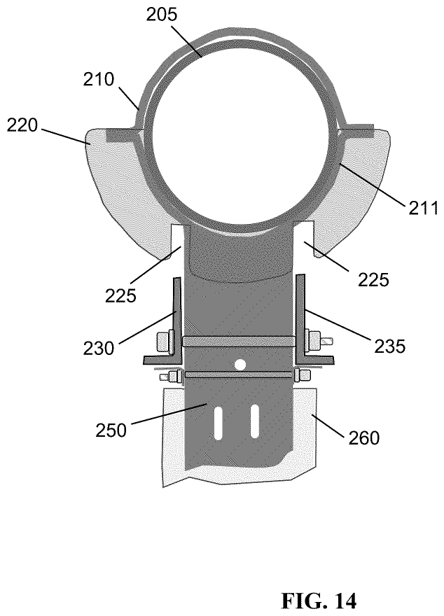

FIG. 14 shows the lock block 230/235 and thrust-stop flanges of the journal 220 in a stow-stop inactive state, according to some embodiments. As shown, the torque tube 205 is shown with 0 degree tilt.

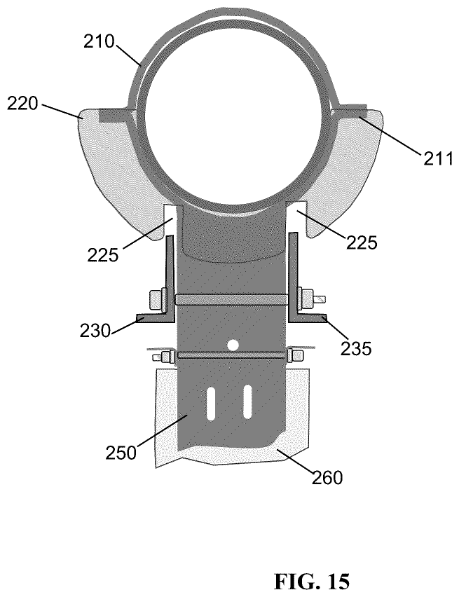

FIG. 15 shows the lock block 230/235 being lifted towards a locking position into the slots 225 of the slots 225, according to some embodiments. Some embodiments rely on the torque tube being strong enough to tilt the solar panels in winds under a certain low specified speed. As the wind increases in speed the somewhat flimsy (low steel weight) torque tube could go into aeroelastic instability and potentially gallop to destruction, even if the PV solar panels are in a flat stowed position. In one or more embodiments, the system moves to a stow position, which is flat, or near flat with a slight tilt of a few degrees, or essentially flat in an up-down attachment of the solar panels to achieve a low center of gravity. The system actuates a pull-cable for the ganged bearing lock, pulling upward a somewhat heavy (a few pounds) steel block with features that get pinched between adjacent moving parts of the bearing's journal 220 and the bearing's race.

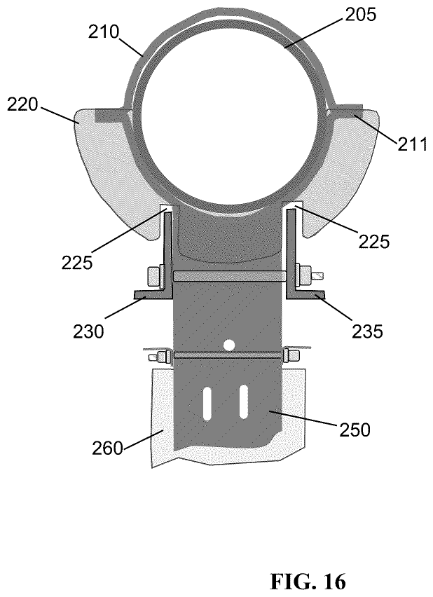

FIG. 16 shows the lock block 230/235 lifted into a locked position within the slots 225, according to some embodiments. As shown, the torque tube 205 is shown with 0 degree tilt with the stow-stop in the active state.

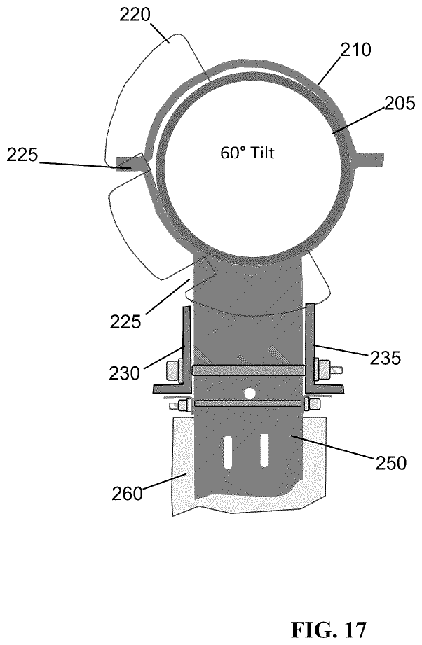

FIG. 17 shows the lock block 230/235 being at rest allowing for rotation of the journal 220 and the torque tube 205, according to some embodiments. As shown, the torque tube 205 is shown with 60 degree tilt with the stow-stop not activated.

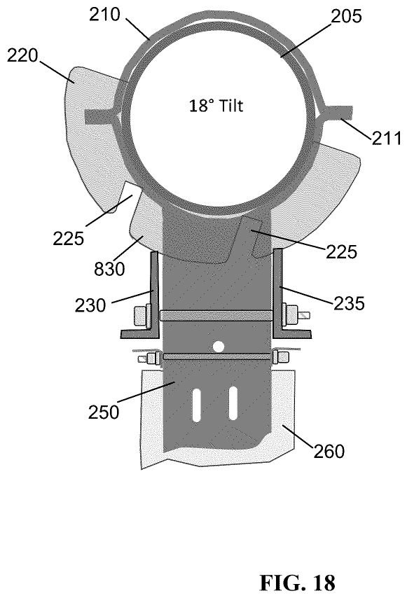

FIG. 18 shows the lock block 230/235 lifted waiting for the torque tube 205 to rotate to a 0 degree position for locking into the slots 225 of the thrust-stop flanges, according to some embodiments. As shown, the stow-stop is activated but cannot yet be pulled into locking position. In one or more embodiments, a spring device is utilized to prevent damage due to over pulling of the wire pull cable in this state.

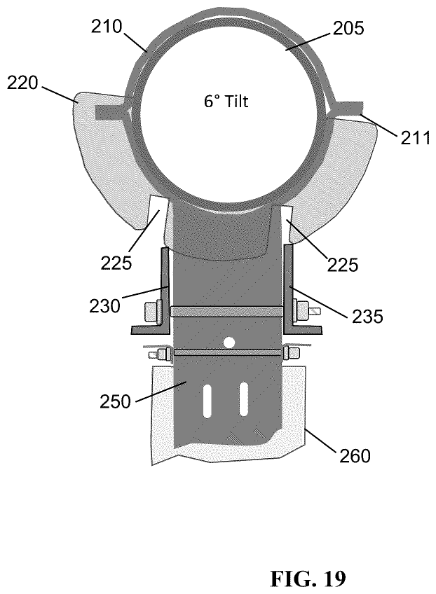

FIG. 19 shows the lock block 230/235 lifted with the torque tube 205 rotating to a 0 degree position for locking into the slots 225 of the thrust-stop flanges, according to some embodiments. The stow-stop is activated, but cannot be pulled into position yet. In one or more embodiments, a spring device is utilized to prevent damage due to over pulling of the wire pull cable in this state.

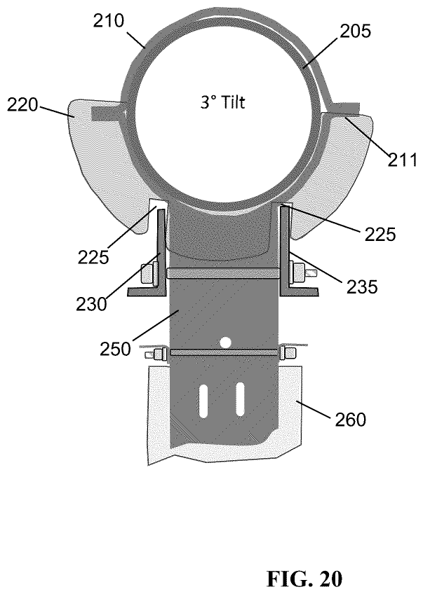

FIG. 20 shows the lock block 230/235 locking the torque tube 205 that was rotated to a ±3 degree position to lock into the slots 225 of the thrust-stop flanges, according to some embodiments. In one or more embodiments, upon the solar panels being tilted, and the ganged bearing lock being inadvertently activated, the locking does not engage. The locking block 230/235 only engages (become pinched and blocks movement) once the solar array attained the stow position. The PV solar panels can continue to turn until the locking block 230/235 are able to move up into a locked, or a pinched position. The ±3 degree tilt and space within the slots 225 provides tolerance or “wiggle” room.

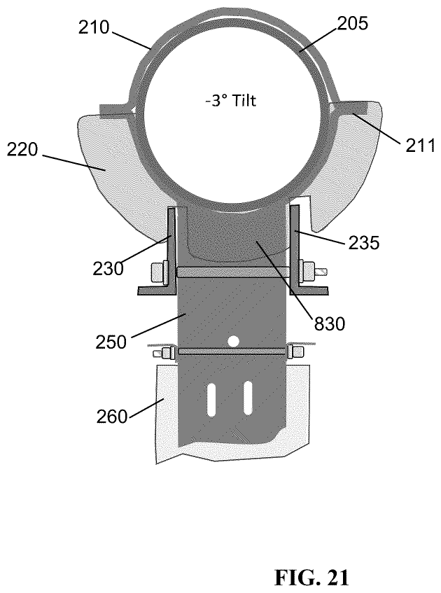

FIG. 21 shows another view of the lock block 230/235 locking the torque tube 205 that was rotated to a ±3 degree position to lock into the slots 225 of the thrust-stop flanges, according to some embodiments. Once the locking blocks 230/235 move, a toggle switch or proximity switch prevents the (actuator) drive from turning on. The drive motor of the actuator only works when the locking blocks 230/235 are disengaged, either from having dropped by gravity (the actuator releases its tensioned pull), or still held out by the non-pinching, or non-trapping portion of the bearing race 210/211 and journal 220. The locking blocks 230/235 may be under spring loaded tension and rub against the moving journal 220, allowing the torque tube 205 and solar panels to turn. Once the slots 225 on the journal 220 are in position to allow the locking blocks 230/235 to be pulled up by the spring tension, the system will be locked (held at every post) and the drive motor ceases to turn.

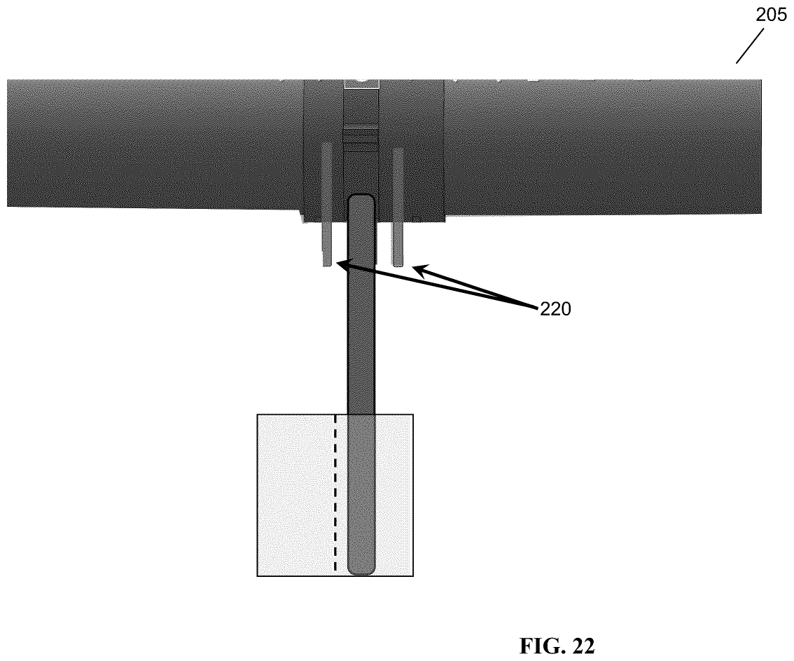

FIG. 22 shows a ganged bearing lock that uses a pull cable to position the lock block, according to some embodiments. The slots 225 (FIG. 2) of the thrust stop flanges are positioned on either side of the bearing race with space (e.g., ¼″, etc.) between the bottom bearing race and inside wall of the thrust stop flanges. The torque tube 205 is shown within the bearing race 220.

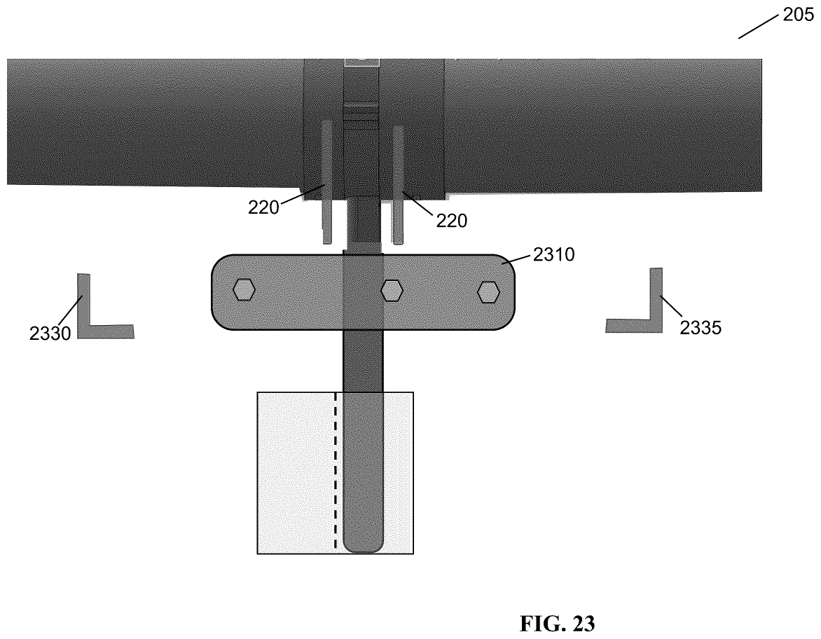

FIG. 23 shows a ganged bearing lock that uses a pull cable to position the lock block that is shown as angle irons 2330/2335, according to some embodiments. In one or more embodiments, the angle irons 2330/2335 are two separate pieces that are fastened together (e.g., bolts, etc.) with sleeves to the connecting plate 2310 to maintain a loose but close fit about the support post neck.

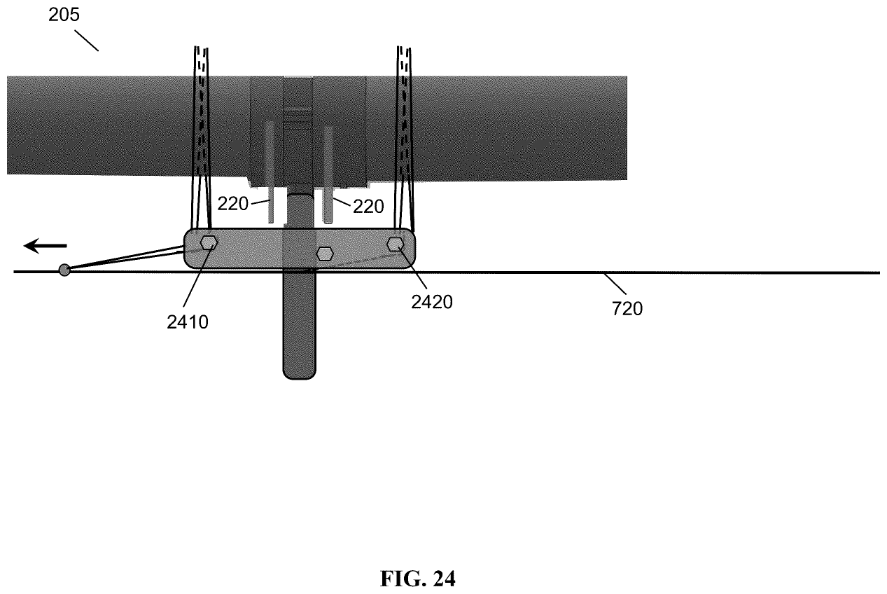

FIG. 24 shows a ganged bearing lock that uses a pull cable 720 to position the lock block that is shown with multiple cables attached, according to some embodiments. In one or more embodiments, four (4) short wire ropes clamp to the main pull cable 720, and loop around the first sleeved fastener 2410 (e.g., bolt, etc.) and the third sleaved fastener 2420 up and over the torque tube 205 (two on each side) and back down to the other side of the lock block. In some embodiments, the pull cable is a galvanized wire rope from the actuator at the drive and out to the last support post.

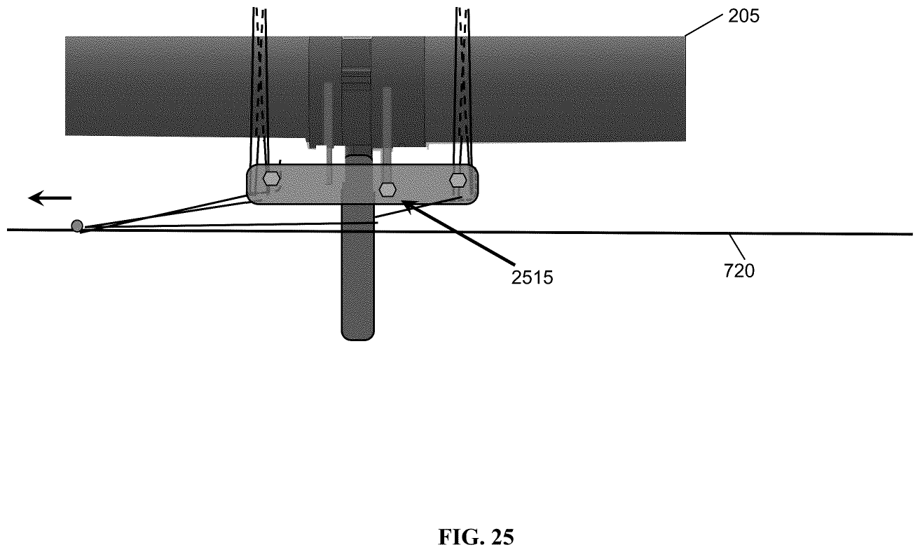

FIG. 25 shows a ganged bearing lock that uses a pull cable 720 to position the lock block 2515 that is shown with one of the fasteners positioned lower than the others for missing the slots, according to some embodiments. In one or more embodiments, the middle (second) bolt is utilized mostly to maintain the stow-stop system from being pulled in the direction of the arrow toward the actuator by the pull on the pull cable 720.

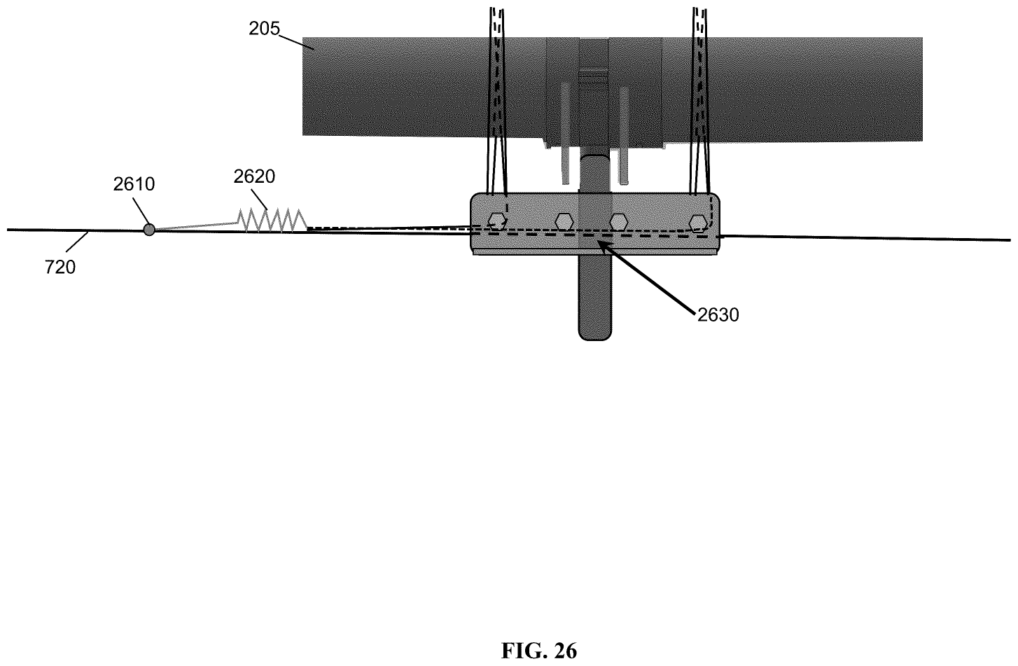

FIG. 26 shows a ganged bearing lock that uses a pull cable 720 to position the lock block that is shown with an optional tension spring 2620 attached to a pull cable 720, according to some embodiments. In one or more embodiments, four short wire cables 2630 are ganged together and clamped to the main pull cable 720 with at least one clamp 2610. The pull cable 720 or the short wire cables 2630 can be interfaced to the actuator with a spring for all bearings to become aligned. In some embodiments, it may be critical to have at least one spring per bearing in case of oscillations prior to locking.

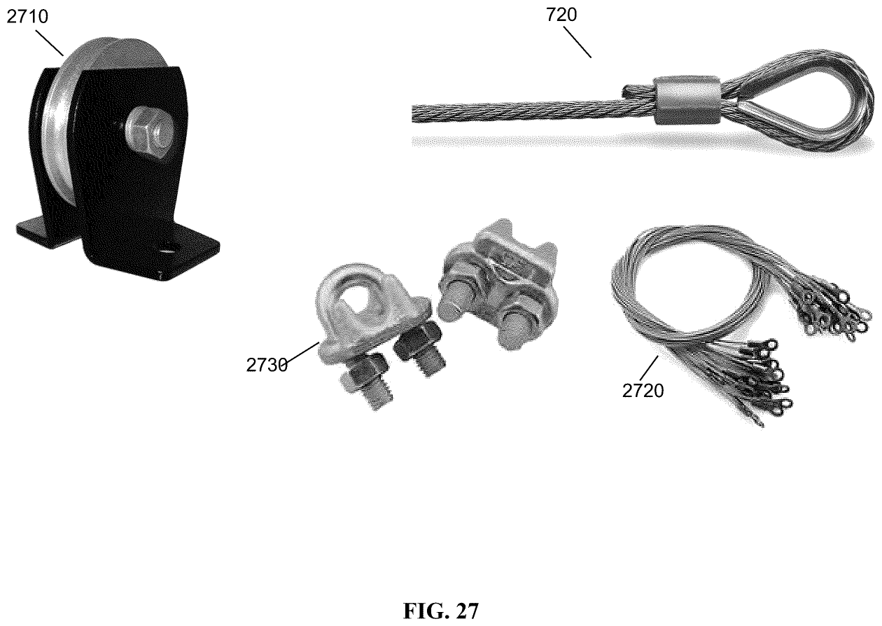

FIG. 27 shows various elements of the pull cable, according to some embodiments. In one or more embodiments, the various elements may include one or more pulleys 2710, a pull cable 720, clamps 2730 and small wire ropes 2720.

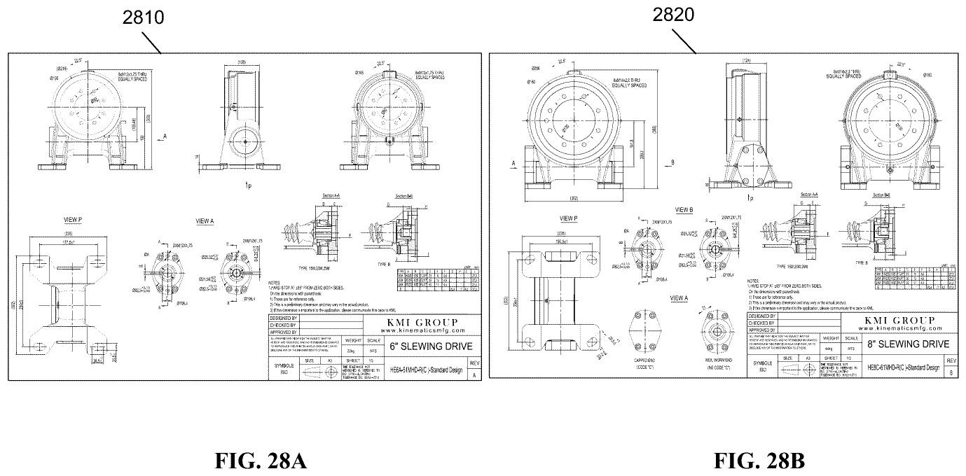

FIG. 28A shows a schematic 2810 for a six (6) inch slew drive, according to some embodiments.

FIG. 28B shows a schematic 2820 for an eight (8) inch slew drive, according to some embodiments.

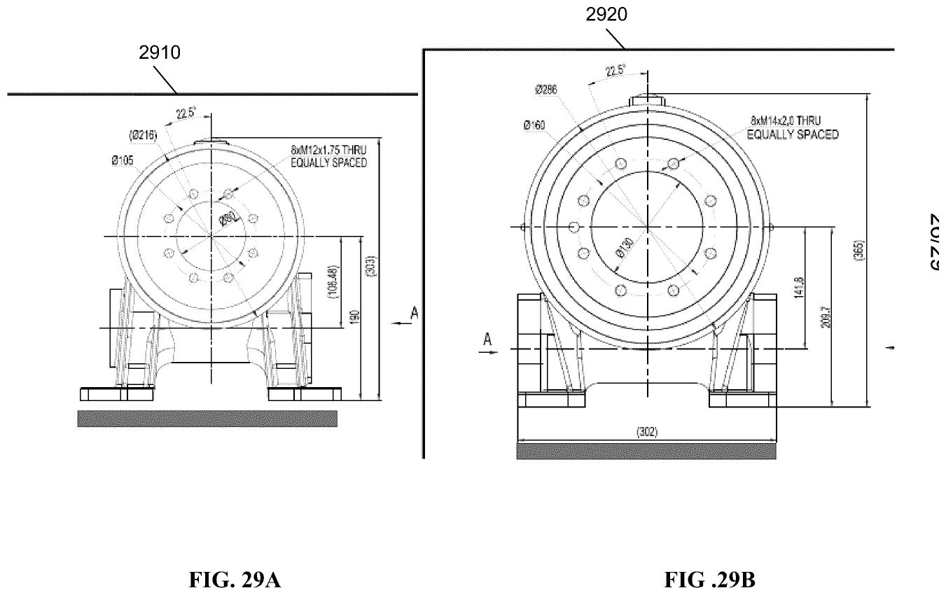

FIG. 29A shows a side view of a schematic 2910 for a six (6) inch slew drive, according to some embodiments.

FIG. 29B shows a side view of a schematic 2920 for an eight (8) inch slew drive, according to some embodiments.

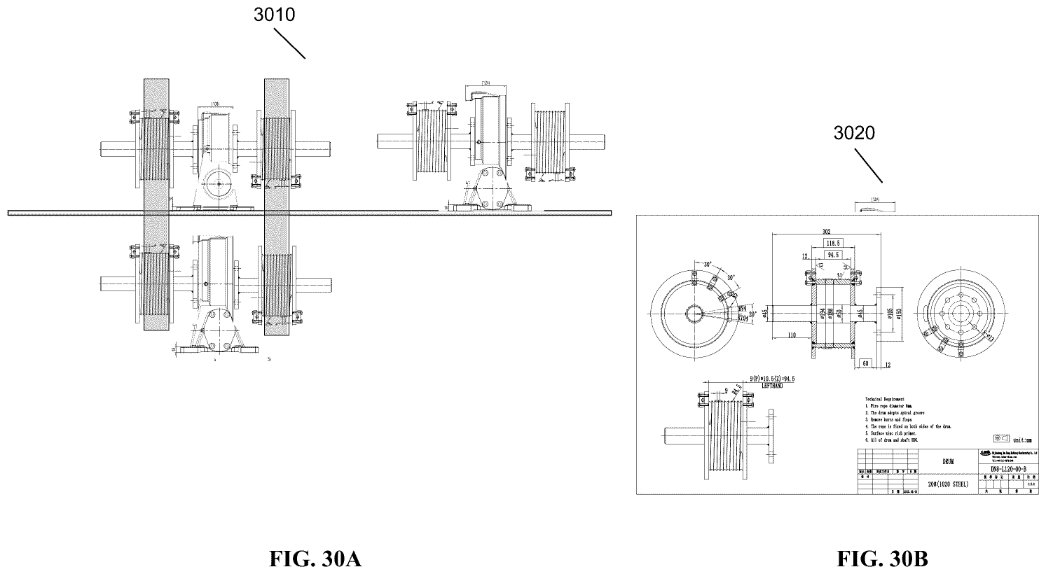

FIG. 30A shows additional views of a schematic 3010 for a slew drive, according to some embodiments.

FIG. 30B shows further additional views of a schematic 3020 for a slew drive, according to some embodiments.

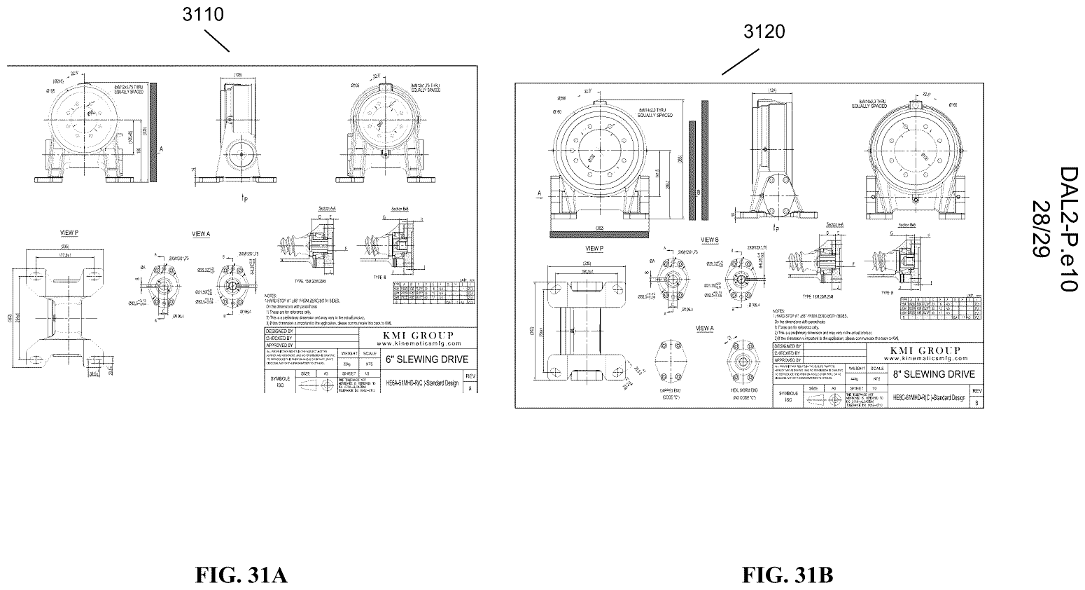

FIG. 31A shows an additional side view of a schematic 3110 for a six (6) inch slew drive, according to some embodiments.

FIG. 31B shows an additional side view of a schematic 3120 for an eight (8) inch slew drive, according to some embodiments.

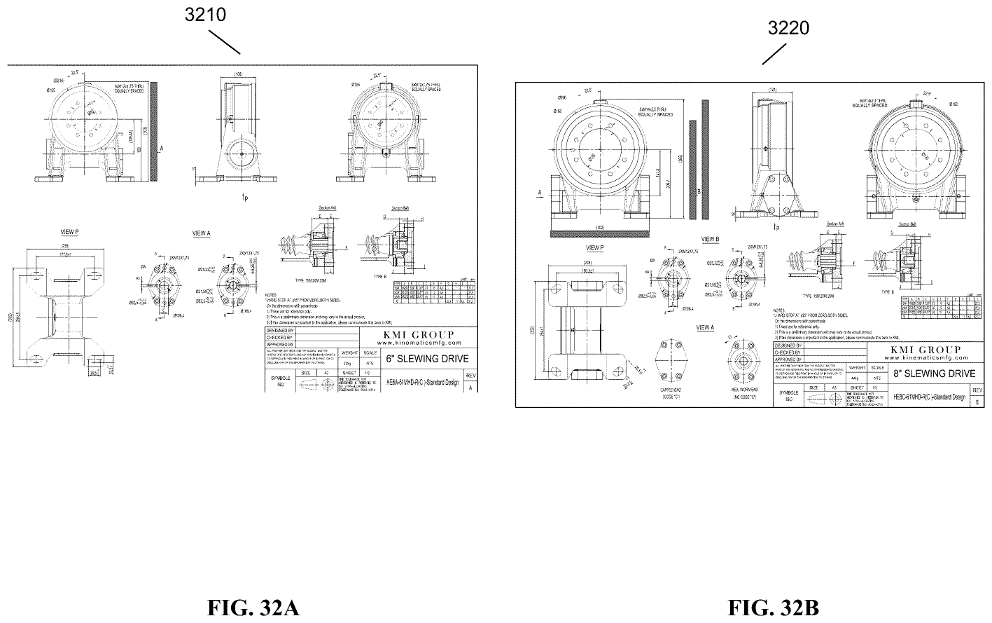

FIG. 32A shows additional views of schematics 3210 for a six (6) inch slew drive, according to some embodiments.

FIG. 32B shows additional views of schematics 3220 for an eight (8) inch slew drive, according to some embodiments.

References in the claims to an element in the singular is not intended to mean “one and only” unless explicitly so stated, but rather “one or more.” All structural and functional equivalents to the elements of the above-described exemplary embodiment that are currently known or later come to be known to those of ordinary skill in the art are intended to be encompassed by the present claims. No claim element herein is to be construed under the provisions of pre-AIA 35 U.S.C. section 112, sixth paragraph, unless the element is expressly recited using the phrase “means for” or “step for.”

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the embodiments has been presented for purposes of illustration and description, but is not intended to be exhaustive or limited to the embodiments in the form disclosed. Many modifications and variations will be apparent to those of ordinary skill in the art without departing from the scope and spirit of the invention.

Though the embodiments have been described with reference to certain versions thereof; however, other versions are possible. Therefore, the spirit and scope of the appended claims should not be limited to the description of the preferred versions contained herein.

What is claimed is:

1. A single-axis tracker system comprising:
a bearing race including a pair of flanges that each include a slot that limits north-south movement of at least one torque tube that is disposed within the bearing race;
a journal-coupler removably coupled to the bearing race; and
a moveable ganged bearing lock holds the at least one torque tube in place while in a stow position.

2. The system of claim 1, wherein each slot captures a locking block of the moveable ganged bearing lock upon the locking block moved upward into place within each slot.

3. The system of claim 2, wherein the locking block is released and pulled out of a locking position via gravity.

4. The system of claim 2, wherein the locking block includes a pair of L-shaped locking portions.

5. The system of claim 4, wherein each of the pair of L-shaped locking positions engage one of the slots in the locking position.

6. The system of claim 1, wherein the journal coupler includes a top portion and a bottom portion, and the top portion removably couples to the bottom portion.

7. The system of claim 6, wherein the bottom portion includes a post coupling portion that couples to a support post.

8. The system of claim 7, wherein the least one torque tube, the bearing race, the journal-coupler, the moveable ganged bearing lock and the support post are each made of metal.

9. The system of claim 1, wherein a wire pull rope coupled with an actuator raises and lowers the locking block in cooperation with a plurality of ganged cables.

10. The system of claim 1, wherein the locking block is coupled to the post coupling portion.

11. A system comprising:
at least one torque tube configured for coupling to one or more photovoltaic (PV) solar panels;
a bearing race including a pair of flanges that each include a slot that limits north-south movement of the at least one torque tube that is disposed within the bearing race;
a journal-coupler removably coupled to the bearing race; and
a moveable ganged bearing lock that holds the at least one torque tube in place while in a stow position.

12. The system of claim 11, wherein each slot captures a locking block of the moveable ganged bearing lock upon the locking block moved upward into place within each slot.

13. The system of claim 12, wherein the locking block is released and pulled out of a locking position via gravity.

14. The system of claim 12, wherein the locking block includes a pair of L-shaped locking portions.

15. The system of claim 14, wherein each of the pair of L-shaped locking portions engage one of the slots in the locking position.

16. The system of claim 11, wherein the journal coupler includes a top portion and a bottom portion, and the top portion removably couples to the bottom portion.

17. The system of claim 16, wherein the bottom portion includes a post coupling portion that couples to a support post.

18. The system of claim 17, wherein the at least one torque tube, the bearing race, the journal-coupler, the moveable ganged bearing lock and the support post are each made of metal.

19. The system of claim 11, wherein a wire pull rope coupled with an actuator raises and lowers the locking block in cooperation with a plurality of ganged cables.

20. The system of claim 11, wherein a wire pull rope coupled with an actuator raises and lowers the locking block in cooperation with a plurality of ganged cables.
